(19) United States
(12) Patent Application Publication
(10) Pub. No.: US 2024/0339705 A1
(43) Pub. Date: Oct. 10, 2024

(54) HERMETIC SEAL STRUCTURE

(71) Applicant: Our Next Energy, Inc., Novi, MI (US)

(72) Inventors: Sanket Sudam Mundhe, Troy, MI (US); Jin Sub Park, Seoul (KR); Seong Woo Park, Commerce Township, MI (US)

(21) Appl. No.: 18/628,633

(22) Filed: Apr. 5, 2024

Related U.S. Application Data
(60) Provisional application No. 63/494,767, filed on Apr. 6, 2023.

(51) Int. Cl. H01M 50/169; H01M 50/103; H01M 50/15; H01M 50/159

(52) U.S. Cl. CPC H01M 50/169; H01M 50/103; H01M 50/15; H01M 50/159

(57) ABSTRACT

A cell that includes a housing, a current collector placed in the housing, and a cap assembly that closes the housing. The cap assembly includes a terminal block, a cap plate, and a terminal insulator disposed between the terminal block and the cap plate. The terminal insulator is brazed at one side to the terminal block and at another side opposite to the one side to the cap plate.

### BACKGROUND

### Technical Field

The present disclosure generally relates to battery cells and more particularly to a battery cell structure with a cap assembly designed to provide a hermetic seal for the cell.

### Description of the Related Art

A battery cell typically includes a housing, a core, a current collecting component, and an upper cover component that make up a majority of the cell structure. The upper cover component usually includes a cover for the housing of the cell and an electrode terminal located on the cover. Components are then welded together to produce the cell.

### SUMMARY

According to an embodiment of the present disclosure, a cell with a hermetic seal structure is disclosed herein. The cell includes a housing extending along a first axis to define a width, a second axis orthogonal to the first axis to define a height, and a third axis orthogonal to the first and second axes to define a thickness. The cell also includes a current collector disposed in the housing, and a cap assembly that closes the housing, the cap assembly including a terminal block, a cap plate, and a terminal insulator. The terminal insulator is positioned between the terminal block and the cap plate and the terminal insulator is brazed on its top side to the terminal block and also brazed on its bottom side to the cap plate.

In one embodiment, the cell may terminal block includes an extension at the bottom side that extends downwards and electrically connects the terminal block to the current collector.

In one embodiment, the current collector includes a protrusion, the terminal block includes a first opening at the top side and a terminal partition material at the bottom side. The terminal insulator further includes a second opening beneath the terminal partition material, a volume of the second opening being larger than a volume of the first opening, the cap plate further includes a third opening, disposed beneath the second opening and can receive the protrusion. The cap plate insulator further includes a fourth opening and a position fixing extension that may confine the protrusion. This design may enable welding the current collector to the terminal partition material of the terminal block from an area external to and outside of the cell.

According to an embodiment, a method of producing a cell is disclosed. The method includes providing a housing extending along a first axis to define a width, a second axis orthogonal to the first axis to define a height, and a third axis orthogonal to the first and second axes to define a thickness. The method also includes disposing a current collector in the housing. The method includes generating a cap assembly to close the housing by providing a terminal block, a cap plate, and a terminal insulator, and disposing the terminal insulator between the terminal block and the cap plate. The terminal insulator is brazed at one surface to the terminal block and at another surface to the cap plate, and the housing is sealed with the cap assembly.

### BRIEF DESCRIPTION OF THE DRAWINGS

To easily identify the discussion of any particular element or act, the most significant digit or digits in a reference number refer to the figure number in which that element is first introduced.

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1A depicts a perspective view of a cell in accordance with an illustrative embodiment.

FIG. 1B depicts a cross section of a cell after assembly in accordance with an illustrative embodiment.

FIG. 2 depicts an exploded view of a cap assembly in accordance with an illustrative embodiment.

FIG. 3 depicts an exploded view of a cap assembly and current collector in accordance with an illustrative embodiment.

FIG. 4 depicts a top view of a cell in accordance with an illustrative embodiment.

FIG. 5A depicts a zoomed in view of a cross section of a cell in accordance with an illustrative embodiment.

FIG. 5B depicts a cross section of a cell showing an external weld.

FIG. 6 depicts a cross section of a cell in accordance with an illustrative embodiment.

FIG. 7 depicts a cross section of a cell in accordance with an illustrative embodiment.

FIG. 8 depicts a routine in accordance with an illustrative embodiment.

FIG. 9 depicts stages of an assembly process in accordance with an illustrative embodiment.

FIG. 10 depicts a functional block diagram of a computer hardware platform in accordance with one embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a cell. As used herein, the term “vertical” describes an orientation that is arranged perpendicular to the first surface of a cell.

As used herein, the terms “coupled” and/or “electrically coupled” are not meant to mean that the elements must be directly coupled together-intervening elements may be provided between the “coupled” or “electrically coupled” elements. In contrast, if an element is referred to as being “directly connected” or “directly coupled” to another element, there are no intervening elements present. The term “electrically connected” refers to an electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to battery cells and their fabrication may or may not be described in detail herein. Moreover, the various tasks and process steps described herein can be incorporated into a more comprehensive procedure or process having additional steps or functionality not described in detail herein. In particular, various steps in the manufacture of cells are well known and so, in the interest of brevity, many conventional steps will only be mentioned briefly herein or will be omitted entirely without providing the well-known process details.

Turning now to an overview of technologies that generally relate to the present teachings, energy density, such as volumetric energy density (VED), may be a primary characteristic used to compare one battery or to another. The amount of energy that can fit inside a given volume is the volumetric energy density. By increasing VED of a battery pack, devices and electric vehicles (EVs) that use the battery pack can stay on for longer or drive farther respectively without increasing the size of the battery pack, thus saving space, weight and manufacturing costs. Further, it may be important to ensure that a cell is hermetically sealed at all times during and in between use to prevent ingress of external material or release of internal material.

The illustrative embodiments recognize that by reducing the size and weight of cell components, more space may be allocated for active materials of electrodes, resulting in an increase in volumetric energy density. The illustrative embodiments further recognize that the cap assembly of a cell is one of the components that may be designed to have a reduced size and a reduced number of components. Further, ensuring that the cell is hermetically sealed is considerably challenging, especially when conventional components are used in cell design due to a large number of interlocking parts, rivets, and connections.

The illustrative embodiments disclose a cell comprising a housing, a current collector disposed in the housing, and a cap assembly that closes the housing. The cap assembly comprises a terminal block, a cap plate, and a terminal insulator disposed between the terminal block and the cap plate, with the terminal insulator being brazed at one side to the terminal block and at another side opposite to the one side to the cap plate.

Various non-limiting embodiments show different terminal structures configured on a cap assembly and brazing techniques.

### Example Architecture

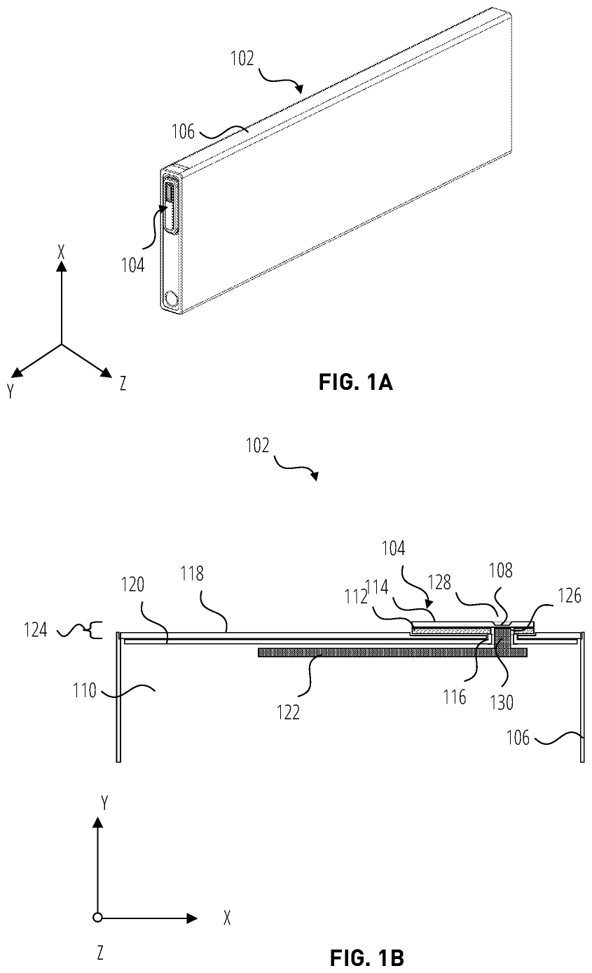

FIG. 1 illustrates a perspective view of a cell 102 comprising a terminal and a housing 106. FIG. 1B show a cross section view of the cell 102. The housing 106 of the cell extends along a first axis (e.g., X-axis) to define a width, a second axis (e.g., Y-axis) orthogonal to the X-axis to define a height, and a third axis (e.g., Z-axis) orthogonal to the first and second axes to define a thickness. The cell may further comprise a cap assembly 124 that includes a terminal block 114, a terminal insulator 112 and a cap plate 118. To reduce the number of individual components making up the cap assembly, the terminal insulator 112 may be brazed, by one or more brazing techniques, to the terminal block 114 and the cap plate 118 as discussed herein.

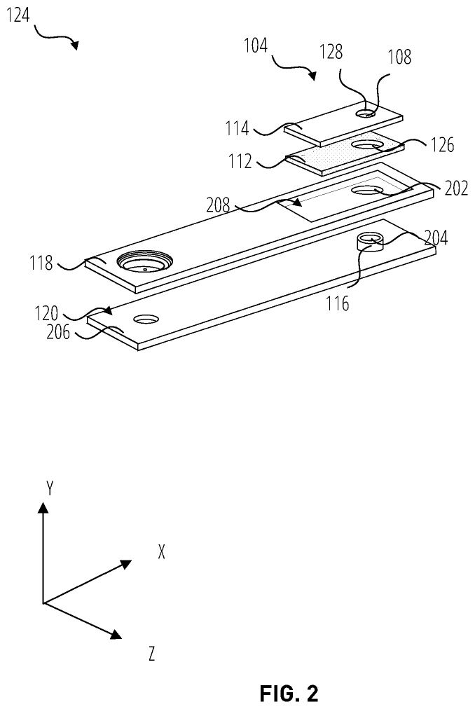

More specifically, as illustrated in FIGS. 1B and 1n the exploded view of the cap assembly 124 in FIG. 2, the cap assembly 124, which may be configured to close the housing, comprises the terminal block 114 that includes a top side in the X-Z plane, and a bottom side below (in the negative Y-axis direction) the top side. The cap assembly 124 further comprises the cap plate 118; and the terminal insulator 112 the includes another top side (top surface) and another bottom side (bottom surface), with the terminal insulator 112 being disposed between the terminal block 114 and the cap plate 118. The terminal insulator may be an electrical insulator and may be made from a ceramic material and may be brazed at its top surface to the terminal block and also brazed at its bottom surface to the cap plate. This may provide a tight hermetic seal as described herein.

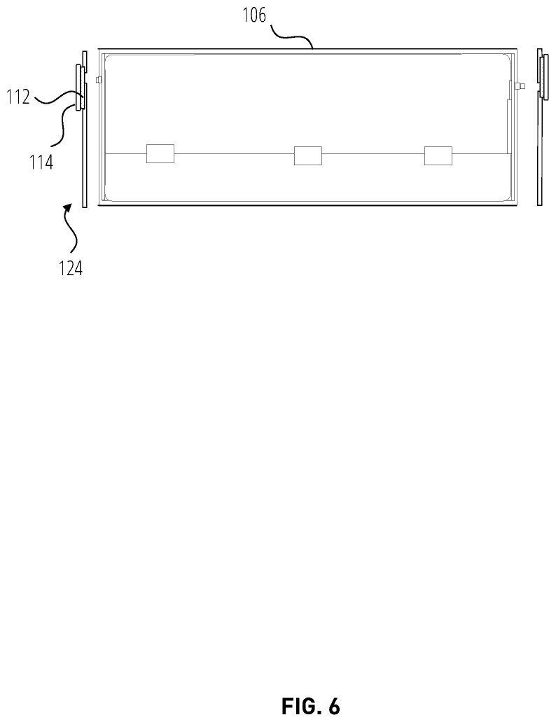

In an illustrative embodiment, the cap assembly may be configured for welding of a current collector 122 disposed inside the housing to the terminal block 114 from an area external to the cell, though this is not meant to be limiting. In such a case, the terminal block 114 may further comprise, a first opening 128 at its top side and a terminal partition material 108 at the bottom side. Further, the terminal insulator 112 may comprise a second opening 126 disposed beneath the terminal partition material, a volume or diameter of the second opening being larger than a volume or diameter of the first opening. The cap plate may further comprise a third opening, disposed directly beneath the second opening and configured to receive the protrusion 130 of the current collector 122 for external welding. A cap plate insulator 120 also comprises a fourth opening 204 and a position fixing extension 116 configured to confine the protrusion 130 when the protrusion 130 is inserted into the fourth opening 204, third opening 202 and second opening 126. In some embodiments, the pillar-shaped protruding structure of the current collector can be manufactured as one body (unibody) with the current collector. In other embodiments, the pillar shaped protrusion can be assembled after separately fabricating the current collector base 206 and the protrusion 130. The protrusion 130 may be a pillar and have a variety of shapes such as circular, semicircular, or polygonal profile. However, the cap assembly need not be configured with openings for external welding as other techniques of welding a current collector to a terminal block in a terminal area 104 of a cap assembly are envisioned and available in light of the descriptions herein, for example as shown in FIG. 6.

Turning back to FIG. 1B, the housing 106 may be a can structure. The current collector 122 may be connected to an electrode plate assembly 110 to charge or discharge electric energy. The housing 106 seals the electrode plate assembly from the outside and the brazing structure of the cap assembly provides a hermetic seal for the cell.

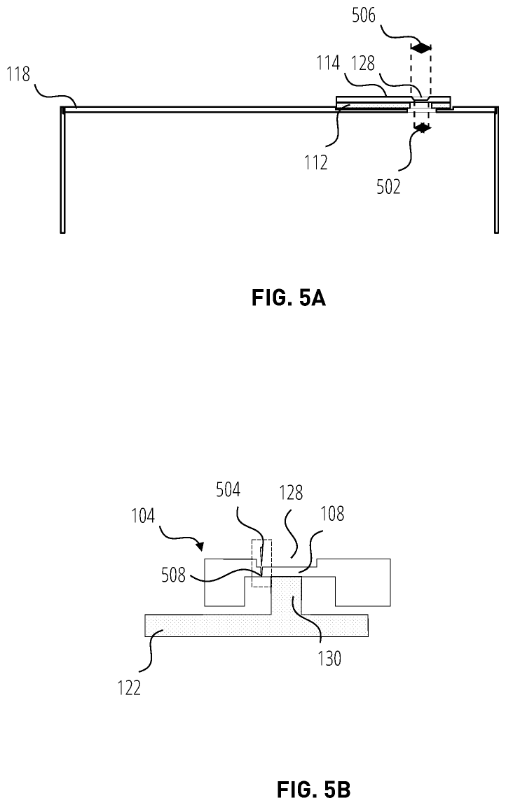

In an embodiment with the cap assembly designed for external welding, the first opening 128 is a cylindrical opening with a first diameter along the X-axis and the second opening 126 is another cylindrical opening with a second diameter along the X-axis, and the second diameter is larger than the first diameter. In another embodiment, the first opening 128 has an upper diameter along the X-axis and a lower diameter along the X-axis, and the second opening 126 is a cylindrical opening with a second diameter along the X-axis, the second diameter being larger than the lower diameter. More specifically, a surface area of the top surface of the protrusion 130 may designed to be larger than the surface area of a bottom surface of the first opening. For example, as shown in the example of FIG. 5A a lower diameter 502 of the first opening is smaller than the upper diameter 506 and also smaller than a diameter of the protrusion (not shown in FIG. 5A), though the diameter of the protrusion may be larger than the upper diameter 506 to avoid leaks 508. Of course, the first opening 128 need not have a circular profile and can have other shapes that prevent the formation of leaks 508 in light of the descriptions herein.

Turning back to FIG. 1B, the electrode plate assembly 110 and the current collector 122 may be electrically coupled and the cap plate insulator 120 may be located between the cap plate 118 and the terminal block 114. In some embodiments, cathode and an anode terminal can be located on the same surface or can be located on different surfaces.

Turning again to FIG. 2, the exploded view of the cap assembly 124 illustrates an embodiment with a depressed volume 208 of the cap plate 118. In the embodiment, at least a portion of the terminal insulator 112 may be disposed in the depressed volume 208 of the cap plate. This may reduce the overall height of the cap assembly 124 and thus enable the allocation of extra space to increase the volumetric energy density of the cell. In an embodiment, the depressed volume of cap plate is no more than half of the total height (in the Y axis) of the cap plate to maintain structural stability. The dimensions of the cell may be configured for optimal cell operation. For example, the terminal block at both a cathode side and at an anode side of the cell may have a height (in the Y-axis) of about 2 mm. As used herein, “about” can include a range of +8% or 5%, or 2% of a given value. In some cases, a height smaller than about 2 mm may have a negative impact such as a temperature rise during operating conditions. The dimensions of the terminal block in the X and Z axes may be about 40 mm and 12 mm respectively. The dimensions of the ceramic insulator may be about 2-3 mm in the Y axis to maintain clearance. The creepage distance from terminal block to cap plate may be more than 1 mm. The dimensions of the cap plate in the Y axis may be more than 2 mm to avoid warping during brazing. The cap plate length and width may be varied as per CAN (Housing) dimension. Implementing these dimensions may ensure that cell operation and longevity of not only the cell but also of the hermetic seal structure is optimized.

In another embodiment, both the terminal insulator 112 and the terminal block 114 may be fully or at least partially disposed in the depressed volume 208 to reduce the overall height of the cap assembly. However, to prevent electrical contact between the sidewalls of the cap plate 118 in the region of the depressed volume 208 and the terminal block 114, the terminal insulator 112 may a height at least equal to the height of the depressed volume 208 and may have another depressed volume (not shown) disposed within the terminal insulator 112 to receive the terminal block such that sidewalls of the terminal block 114 only make contact with sidewalls of the terminal insulator 112 in the another depressed volume of the terminal insulator 112. For example, the terminal insulator can have a height X equal or higher than the height of the depressed volume 208 but can itself have another depression in which the terminal block 114 is disposed so that the terminal block sidewalls do not come into contact with the sidewalls of the cap plate in the area of the depressed volume 208. Such a configuration may further reduce the height and thus volume occupied by the cap assembly and thus increase the VED of the cell and of the corresponding battery pack.

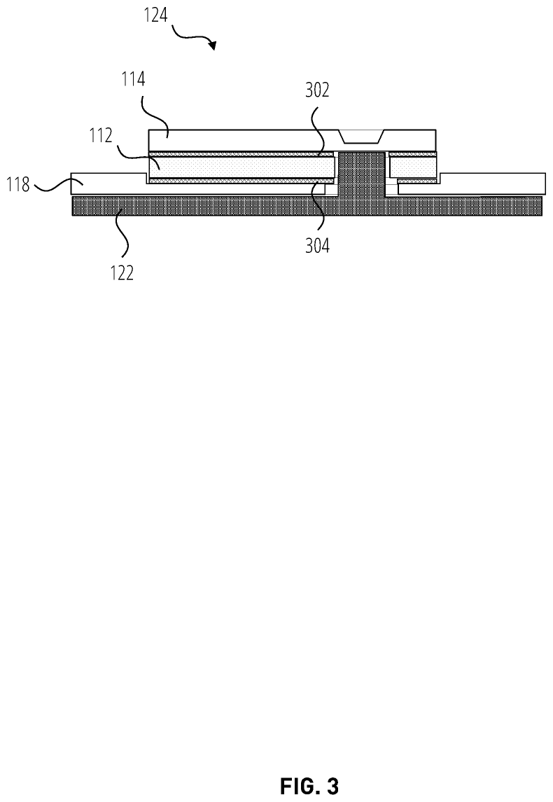

FIG. 3 illustrates a zoomed in cross section of a cap assembly 124. As discussed, the terminal insulator 112 may be brazed, by one or more brazing techniques, to the terminal block 114 and the cap plate 118 as discussed herein. Brazing may enable the joining of dissimilar materials by melting a filler material into a joint to create strong permanent bonds while keeping the mechanical properties of the joined materials. Brazing may enable surface bonds that reduce or eliminate the risk of moisture ingress and hence provides a hermetic seal that is better than a conventional seal and that increases the mechanical strength of the seal due to the inherent mechanical properties of ceramic. More specifically, ceramic, which has excellent resistance to a wide range of chemicals, works well in high heat conditions and has minimal aging defects may be used. Brazing creates a unified bond between metal and ceramic by removing or alleviating the risk of moisture ingress along the surface of the mating parts. In brazing, a small joint spacing may be used to allow capillary action to draw the filler material into the joint. In some cases, a flux material may also be used to remove oxides that form from heating of the parts and promote wetting. Further, one or more of the parts to be joined together may be plated to prevent oxidation during heating.

In FIG. 3, the first brazed joint 302 and the second brazed joint 304 may be generated by the same or different techniques including active brazing and vacuum brazing. In active brazing, an active element, such as titanium, zirconium, or chromium, may be used in the brazing filler material. A solid, metallurgical bond is formed when the active element interacts with the base materials being joined. The active element in the filler material may have a strong affinity for the base materials and may react readily therewith, enabling the reduction of the surface tension of the molten filler metal, and allowing it to flow more easily into tight spaces and to achieve a stronger bond. For example, titanium and zirconium may be used as active elements in brazing filler materials because they readily react with metals such as aluminum. Active brazing may thus, create high-strength, high-reliability joints and enable the joining of dissimilar metals, such as ceramic to metal. In some cases, to prevent oxidation, one or more of the parts being joined together may be plated with a material that prevents oxidation when the parts are heated.

Vacuum brazing, may also be used to join dissimilar materials together. The parts to be joined together and the filler material/metal may be heated in a vacuum chamber, which creates a controlled environment that is free from air and other impurities. The temperature and heating rate may be carefully controlled to ensure that the parts being joined do not deform. The vacuum environment helps to remove any oxide or prevent the formation of brittle intermetallic compounds that weaken the joint, thus, helping to improve the strength and reliability of the joint.

In an aspect herein, the first brazed joint 302 and the second brazed joint 304 may be formed by active brazing. In another aspect the first brazed joint 302 and the second brazed joint 304 may be formed by vacuum brazing. In a third aspect, the first brazed joint 302 may be formed by active brazing and the second brazed joint 304 may be formed by vacuum brazing and vice versa. The terminal insulator 112 may comprise a ceramic material (such as alumina, more specifically 95%, 98%, or 100% Al₂ O₃) and thus the brazing techniques may join dissimilar materials of ceramic and metal together. In an embodiment, the metal surface (for example, aluminum material of the terminal block 114) may be plated with Ni or Cu during non-vacuum brazing to avoid oxidation. More specifically, for an anode side of the cell, the terminal block can be coated with Ni or Cu and the cap plate can be coated with Tin (Sn), whereas for the cathode side the terminal and cap plate can be coated with Tin (Sn). This may be important to avoid the galvanic corrosion of base metal (Al Alloy).

In an aspect, the cap plate 118, housing 106 and/or terminal block 114 comprises an aluminum alloy. In yet another aspect, one of the joints may be a brazed joint and the other may not.

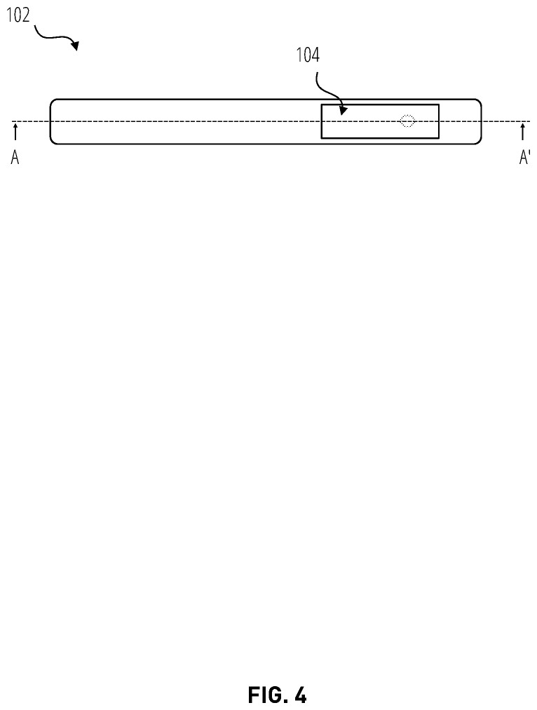

FIG. 4 illustrates a top view of a cell 102 illustrating a position of the terminal area 104. Due to the reduction in the number of components used in the terminal area 104 relative to conventional components, a relatively larger area is available for the terminal to occupy and thus for connection of the terminal to a busbar. In an embodiment, the cell may be a prismatic cell. A battery pack may be manufactured to include a plurality of the cells 102.

FIG. 5A depicts a cross section of a cell in the A-A′ plane of FIG. 4 illustrating the openings configured to receive the protrusion/pin of the current collector. FIG. 5B illustrates the leaks that may be formed when the diameter of the protrusion 130 is less than that of the first opening 128.

Though the embodiment shown in the FIG. 5A depicts a first opening 128 for welding the protrusion of a current collector to the terminal block 114 from an area external to the cell, other embodiments may employ other designs such as the embodiment of FIG. 6 which illustrates a cross section through the housing 106 and cap assembly of a cell without an external welding structure. More specifically, the current collector may still be connected to the terminal block without a need for the first opening 128, second opening 126, third opening 202 or fourth opening 204.

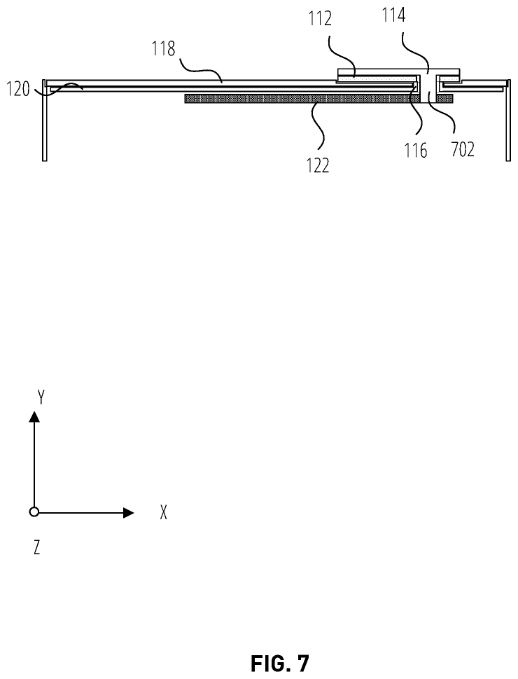

FIG. 7 illustrates another embodiment wherein the terminal block 114 has an extension 702 that extends from the bottom of the terminal block in the negative Y-axis direction and makes electrical and/or physical contact with the current collector 122 at a position that is further down and inside the cell (for example, below the position fixing extension 116), as opposed to near a terminal partition material. Thus, external welding may be unused here. In an illustrative embodiment, a hole may be created in the current collector 122 to receive the extension 702, though the extension may be bonded to the current collector 122 by one or more bonding techniques.

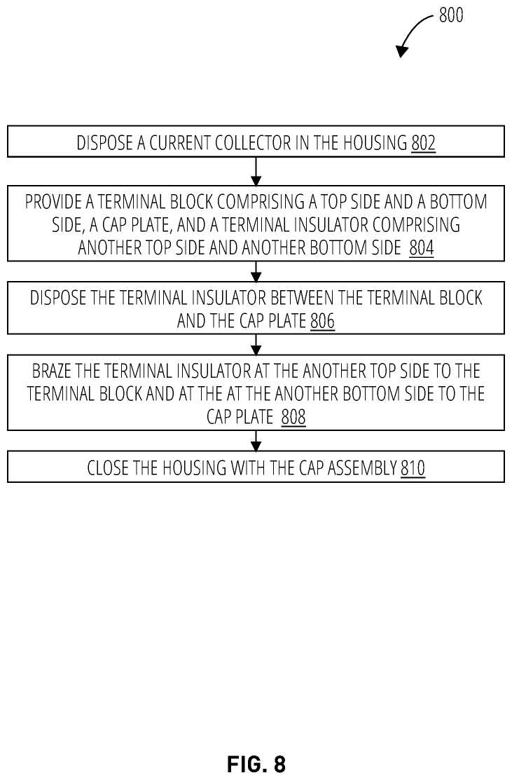

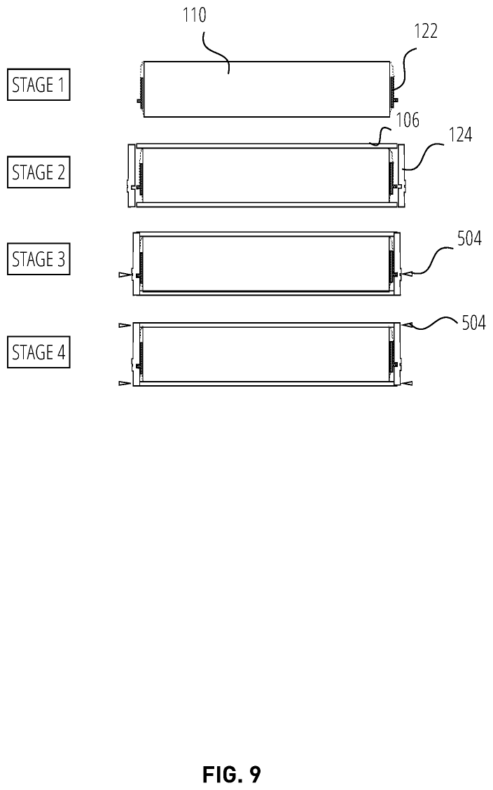

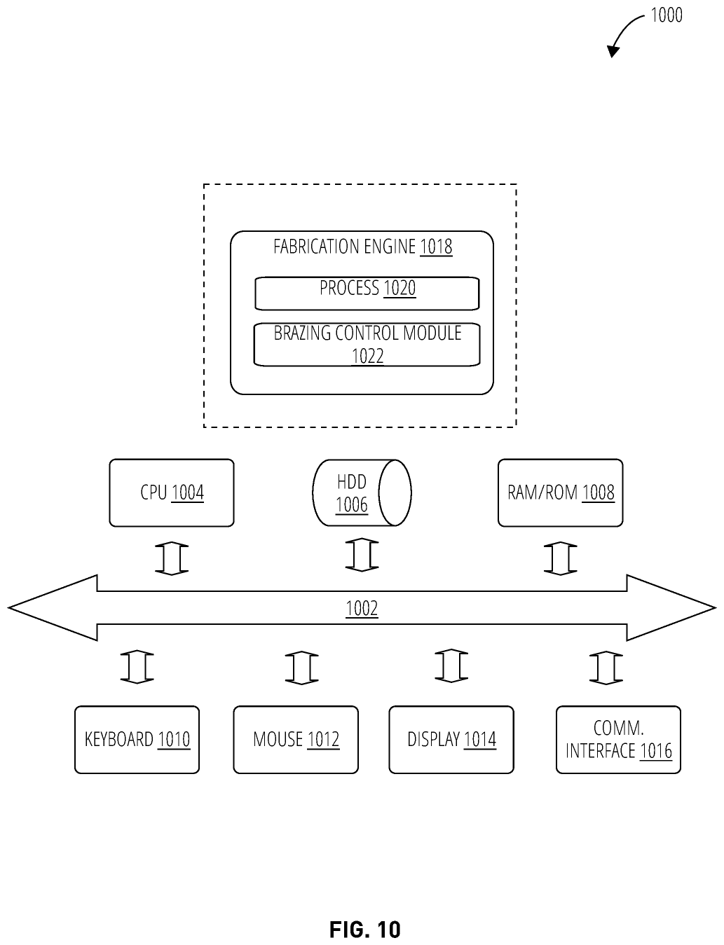

FIG. 8 depicts a routine 800 for fabricating a cell with a first and a second brazed joint. The process is illustrated by the stages of FIG. 9. The routine 800 may further be performed by an engine such as fabrication engine 1018 of FIG. 10. The routine may begin by the fabrication engine 1018 providing a housing extending along a first axis to define a width, a second axis orthogonal to the first axis to define a height, and a third axis orthogonal to the first and second axes to define a thickness. An electrode plate assembly 110 is also provided as illustrated in STAGE 1 of FIG. 9.

In block 802, fabrication engine 1018 may dispose a current collector in the housing. The fabrication engine may generate a cap assembly by providing, in block 804, a terminal block comprising a top side and a bottom side, a cap plate, and a terminal insulator comprising another top side and another bottom side. The fabrication engine 1018 disposes the terminal insulator between the terminal block and the cap plate and brazes the terminal insulator at the another top side to the bottom side of the terminal block and at the at the another bottom side of the terminal insulator to a top side of the cap plate. Responsive to generating the cap assembly, the fabrication engine 1018 electrically connects the terminal to the current collector by an internal or external connection process and closes the housing with the cap assembly in block 810.

In the embodiment wherein external welding of the current collector to the terminal is employed, the fabrication engine 1018 closes the housing 106 using the cap assembly 124 by inserting a protrusion 130 of the current collector into the second opening 126 to dispose it adjacent to the terminal partition material 108 (See STAGE 2, FIG. 9). The fabrication engine 1018 welds, from an area external to the cell and through the first opening 128, the terminal partition material 108 of the terminal to the current collector 122 to generate a terminal-to-current collector weld (STAGE 3, FIG. 9). The welding may be performed by laser welding, friction welding, ultrasonic welding, etc., and may be performed using the welding device 504. The routine 800 may further comprise welding the cap assembly 124 to the housing 106 to close the cell as shown in STAGE 4 of FIG. 9. Other technical features may be readily apparent to one skilled in the art from the figures, descriptions, and claims. While the components and manufacture of a cell with an external welded structure are described for the purposes of discussion, it will be understood that other configurations, as well as other fabrication processes are supported by the teachings herein.

### Example Computer Platform

As discussed above, functions relating to methods and systems for fabricating a cell with a cap assembly comprising a hermetic seal can use of one or more computing devices connected for data communication via wireless or wired communication. FIG. 10 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or combination of hardware and software can be used as well. The computer platform 1000 may include a central processing unit (CPU) 1004, a hard disk drive (HDD) 1006, random access memory (RAM) and/or read only memory (ROM) 1008, a keyboard 1010, a mouse 1012, a display 1014, and a communication interface 1016, which are connected to a system bus 1002.

In one embodiment, the hard disk drive (HDD) 1006, has capabilities that include storing a program that can execute various processes, such as the fabrication engine 1018, in a manner described herein. The fabrication engine 1018 may have various modules configured to perform different functions. For example, there may be a process module 1020 configured to control the different manufacturing processes discussed herein and others. There may be a brazing control module 1022 operable to provide an appropriate temperature, filler material and duration for brazing a ceramic terminal insulator 112 to a terminal block 114 at a first surface and to a cap plate 118 at a second surface opposite the first surface.

For the sake of brevity, conventional techniques related to making and using aspects of the invention may or may not be described in detail herein. In particular, various aspects of manufacturing and computing systems and specific programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A cell comprising:
a housing extending along a first axis to define a width, a second axis orthogonal to the first axis to define a height, and a third axis orthogonal to the first and second axes to define a thickness;
a current collector disposed in the housing, and
a cap assembly that closes the housing, the cap assembly comprising:
a terminal block comprising a top side, and a bottom side,
a cap plate; and
a terminal insulator comprising another top side, another bottom side, the terminal insulator disposed between the terminal block and the cap plate, the terminal insulator brazed at the another top side to the terminal block and also brazed at the another bottom side to the cap plate.

2. The cell of claim 1, wherein the terminal insulator is a ceramic material.

3. The cell of claim 2, wherein the ceramic material comprises Al₂ O₃.

4. The cell of claim 1, wherein the cap plate or housing or terminal block comprises an Al alloy.

5. The cell of claim 1, wherein at an anode side of the cell the terminal block is coated with Ni or Cu and the cap plate is coated with Sn.

6. The cell of claim 1, wherein at a cathode side of the cell the terminal block and the cap plate are coated with Sn.

7. The cell of claim 1, wherein the terminal insulator is an electrical insulator.

8. The cell of claim 1, wherein:
the current collector further comprises a protrusion,
the terminal block further comprises, a first opening at the top side and a terminal partition material at the bottom side,
the terminal insulator further comprises a second opening disposed beneath the terminal partition material, a volume of the second opening being larger than a volume of the first opening,
the cap plate further comprises a third opening, disposed beneath the second opening and configured to receive the protrusion; and
the cap plate insulator further comprises a fourth opening and a position fixing extension configured to confine the protrusion.

9. The cell of claim 8, wherein the current collector is disposed in the second opening and welded to the terminal at the first opening to form a terminal-to-current collector weld at an external area of the cell.

10. The cell of claim 1, wherein the terminal block further comprises an extension at the bottom side that extends downwards and electrically connects the terminal block to the current collector.

11. The cell of claim 1, wherein at least a portion of the terminal insulator is disposed in a depressed volume of the cap plate.

12. The cell of claim 11, wherein both the whole terminal insulator is disposed in the depressed volume of the cap plate.

13. A battery pack comprising the cell of claim 1 and a plurality of other cells each designed based on the cell.

14. The cell of claim 1, wherein the protrusion is a pillar shaped protrusion.

15. The cell of claim 1, wherein the cell is a prismatic cell.

16. A method of producing a cell comprising:
providing a housing extending along a first axis to define a width, a second axis orthogonal to the first axis to define a height, and a third axis orthogonal to the first and second axes to define a thickness;
disposing a current collector in the housing;
generating a cap assembly to close the housing by:
providing a terminal block comprising a top side and a bottom side, a cap plate, and a terminal insulator comprising another top side and another bottom side;
disposing the terminal insulator between the terminal block and the cap plate;
brazing the terminal insulator at the another top side to the terminal block and at the at the another bottom side to the cap plate; and
closing the housing with the cap assembly.

17. The method of claim 16, wherein the brazing comprises at least one of active brazing and vacuum brazing.

18. The method of claim 16, wherein:
the terminal insulator is a ceramic and the brazing is performed between a metal surface and the ceramic.

19. The method of claim 16, further comprising:
minimizing a height of the cap assembly by disposing at least a portion of the terminal insulator in a depressed volume of the cap plate.

20. The method of claim 16, welding, from an area external to the cell and through a first opening, a terminal partition material of the terminal block to the current collector.
